(19) United States
(12) Patent Application Publication
(10) Pub. No.: US 2024/0099914 A1
(43) Pub. Date: Mar. 28, 2024

(54) WHEELCHAIR WHEEL LOCK SYSTEM

(71) Applicant: Push Lox, LLC, Troy, MO (US)

(72) Inventor: Clayton Braun, Troy, MO (US)

(73) Assignee: Push Lox, LLC, Troy, MO (US)

(21) Appl. No.: 18/371,041

(22) Filed: Sep. 21, 2023

Related U.S. Application Data
(60) Provisional application No. 63/376,890, filed on Sep. 23, 2022.

(51) Int. Cl. A61G 5/10

(52) U.S. Cl. CPC A61G 5/101; A61G 5/1027; A61G 5/1035

(57) ABSTRACT

A wheelchair wheel lock system for a wheelchair having a wheel lock plate with a locking face. The system includes a control cable, a lock-pin, a remote actuator and a biasing member. The control cable operatively connects the lock-pin with the remote actuator. The lock-pin is positioned proximate the locking face and selectively engages and disengages with the locking face when urged by the actuator. The biasing member urges the lock-pin to disengage from the locking face.

### CROSS REFERENCE TO RELATED APPLICATIONS

This application derives and claims priority from U.S. provisional application 63/376,890, filed Sep. 23, 2022, and having Attorney Docket No. PUSH H004US, which application is incorporated herein by reference.

### STATEMENT REGARDING FEDERALLY SPONSORED RESEARCH OR DEVELOPMENT

Not applicable.

### BACKGROUND OF THE INVENTION

This invention relates principally to a system that remotely engages and disengages a wheelchair wheel lock, and more particularly to a robust wheelchair wheel lock system in which the locking mechanism is operated by a hand-actuated lever subassembly that remotely engages and disengages the lock, the lever subassembly incorporating a feature that minimizes the chance that the wheel lock will engage should the wheel lock system fail.

The present disclosure comprises improvements to various wheelchair wheel lock systems, including for example the disclosure presented in U.S. Pat. No. 6,341,671 to Ebersole for a WHEELCHAIR PARKING BRAKE (the '671 Patent), commercial versions of the wheelchair parking brake disclosed and claimed in the '671 Patent, and Applicant's own U.S. patent application Ser. Nos. 17/669,432 and 17/669,436, which are incorporated by reference herein. As explained in the '671 Patent: “Existing wheelchair wheel locks based on friction between a moveable portion of a brake, or lock, and the tire or wheel of the wheelchair suffer in effectiveness in that a limited area of contact between the brake and the wheel permit the wheel to slip and rotate under high lateral loads, such as during the egress of the wheelchair occupant from the wheelchair. It is desirable that wheelchair parking brake, or lock, should substantially preclude any further wheel rotation whatsoever, once engaged, nonetheless to being easy and reliable to engage and dis-engage.” (1:13-22). The '671 Patent and Applicant's Ser. Nos. 17/669,432 and 17/669436 Applications disclose wheelchair wheel systems that overcome such concerns.

However, such wheelchair parking brake or “wheel lock” systems, including the '671 Patent and Applicant's Ser. Nos. 17/669,432 and 17/669436 Application systems, all are designed with a lock-pin that engages a lock plate, and a biasing member (typically, a spring) positioned near or directly against the lock-pin. In these traditional designs, the biasing member urges the lock-pin to engage the lock plate. Thus, when the system encounters an operational or mechanical failure, such as for example the breakage of the cable operating the lock-pin, the biasing member will automatically force the lock-pin to engage its respective lock plate, and thereby lock that wheel, even if the lock-pin was disengaged when the failure occurred. This has been found in some circumstances to be very undesirable.

That is, when a wheelchair wheel locks due to a failure of the wheel lock system, that wheel will be unable to rotate until the failure has been resolved or the lock-pin has been physically disengaged from the lock plate. Thus, the wheelchair user will be unable, without tools and/or much effort, to move his/her wheelchair under such circumstances. This is particularly significant in that most individuals requiring wheelchairs suffer from various degrees of physical incapacities that make such circumstances even more difficult to overcome or correct.

In addition, traditional wheel lock systems utilize cables that have a sleeve surrounding a central wire that can move axially within the sleeve. In traditional systems, a ferrule is attached to the ends of the cable, and the ferrule is slipped into an opening in a housing to interface with the system's lock-pins or actuator. Other constraints on the cable, such as for example, clamps or brackets positioned along the length of the cable, are intended to secure each ferrule in a set position within its respective opening. Unfortunately, it has been found that in this traditional configuration the ferrules often will often pull out of their respective openings, and cause a system failure.

It would therefore be desirable to have a wheelchair wheel lock system that does not automatically urge the lock-pin into engagement with the lock plate when the wheel lock system encounters a mechanical or operational failure. It would also be desirable to have a wheelchair wheel lock system in which the cables are more secure. As will become evident in this disclosure, the present invention provides such improvements over the existing art.

### BRIEF DESCRIPTION OF THE DRAWINGS

The illustrative embodiments of the present invention are shown in the following drawings which form a part of the specification:

FIG. 1 is a perspective view of a representative self-retracting wheelchair wheel lock system incorporating a first embodiment of the present invention, the system being attached to a representative wheelchair frame depicted in phantom lines;

FIG. 2 is an underside view of the wheel lock system of FIG. 1, with the lock-pins disengaged from the wheels;

FIG. 3 is an underside view of the wheel lock system of FIG. 1, with the lock-pins engaging the wheels;

FIG. 4 is a perspective view of the lock-pin assembly of the wheel lock system of FIG. 1;

FIG. 5 is an exploded perspective view of the lock-pin assembly of FIG. 4;

FIG. 6 is a perspective view of the actuator of the wheel lock system of FIG. 1;

FIG. 7 is an exploded perspective view of the actuator of FIG. 6;

FIG. 8 is a cross-sectional top view of the actuator of FIG. 6;

FIG. 9 is a perspective vertical cross-sectional view of the actuator of FIG. 6;

FIG. 10 is a side view of the housing for the actuator of FIG. 6;

FIG. 11 is a perspective view of the piston subassembly of the actuator of FIG. 6;

FIG. 12 is an exploded perspective view of the piston subassembly of FIG. 11;

FIG. 13 is a perspective view of the piston body of the piston subassembly of FIG. 11;

FIG. 14 is a perspective view of the representative wheelchair wheel lock plate depicted in FIGS. 1-3;

Corresponding reference characters indicate corresponding parts throughout the several views of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

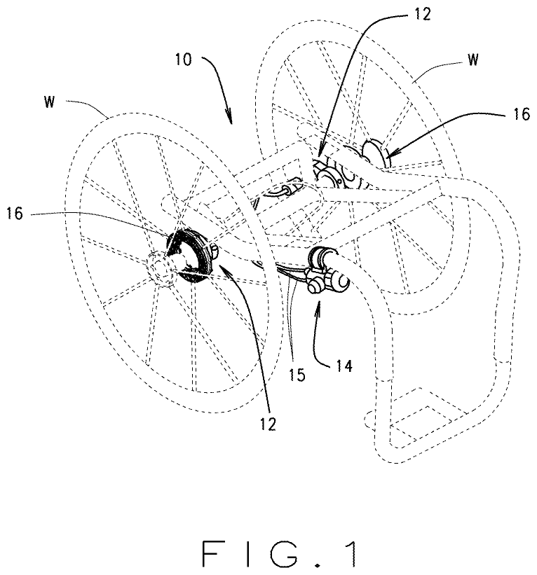

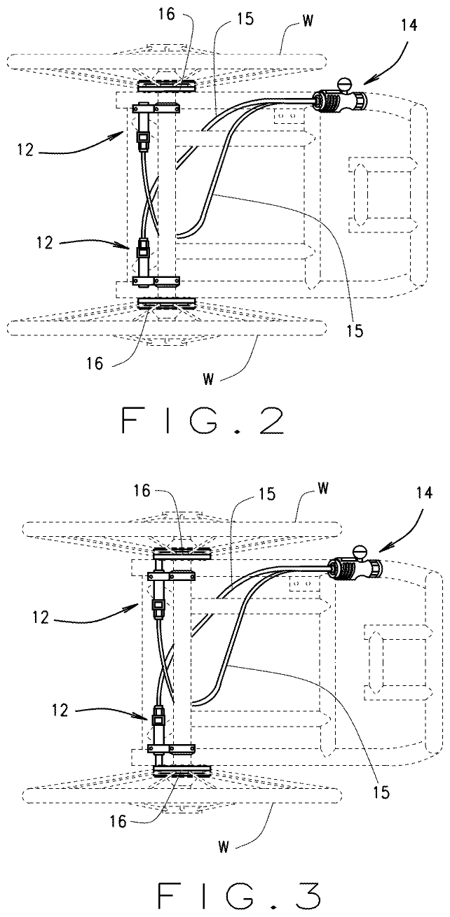

In referring to the Figures, a first representative embodiment of the present disclosure, generally referred to as an improved wheelchair wheel lock system 10, is shown generally by way of example in FIGS. 1-3, where it is depicted in association with a representative wheelchair W. As can be seen, the wheel lock system 10, constructed primarily of high-strength polymers along with various metal components, includes a pair of lock-pin assemblies 12, a remote actuator 14, and a set of actuation or control cables 15, often referred to as “Bowden” cables, connecting the actuator 14 to the lock-pin assemblies 12. The lock-pin assemblies 12 each interface with a different corresponding wheel lock plate assembly attached to one of wheels of the wheelchair W, such as for example the representative plate assemblies 16.

### Representative Lock Plate Assemblies

Each of the representative plate assemblies 16 in this disclosure substantially mimics the first embodiment of the plate assemblies of Applicant's application Ser. No. 17/669,436, said Application being incorporated in its entirety by reference herein. However, alternate lock plate assemblies may be used so long as they are capable of interfacing with the wheel lock system 10 in the manner as disclosed herein.

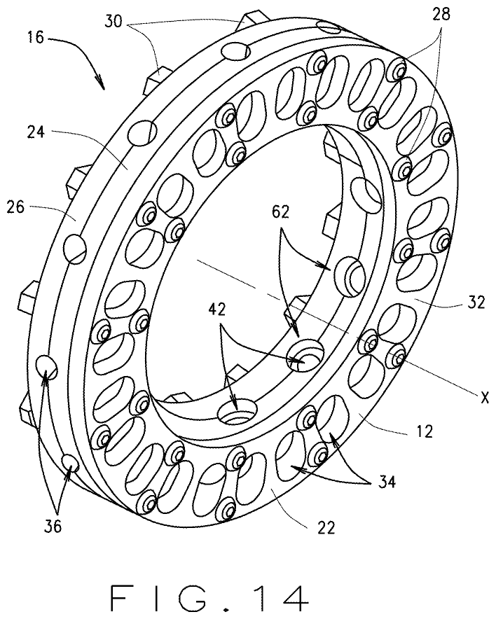

Referring to FIG. 14, and additionally in reference to the disclosures contained in application Ser. No. 17/669,436, each representative lock plate assembly 16 includes a ring-shaped lock plate or inner plate 22, a ring-shaped central plate 24 and a ring-shaped outer plate 26. The inner plate 22 is constructed of a lightweight metal such as for example aluminum alloy, while the central plate 24 and the outer plate 26 are both constructed of a high-strength, elastic, slightly pliant polymer, such as for example Nylon-11. All of the plates 22, 24 and 26 are generally flat, and all share the same inner diameter of approximately 2.75 inches, and the same outer diameter of approximately 4.00 inches. The inner plate 22 has an overall thickness of approximately ¼ inch, the central plate 24 has an overall thickness of approximately ¼ inch, and the outer plate 26 has an overall thickness of approximately 3/16 inch. Of course, these dimensions can be altered to fit different wheelchairs with particular hub and/or spoke configurations. Each plate assembly 16 further has a set of twenty-four identical steel machine screws 28 that extend through the three plates 22, 24 and 26 to mate with twenty-four matching nylon machine screw lock nuts 30 that thread onto the screws 28 to secure the three plates 22, 24 and 26 together.

The inner plate 22 has a generally flat inner face 32, central axis X, and a set of twenty-four slightly flattened and radially aligned elliptical openings 34 in the inner face 32 that form a uniform circular pattern about the plate 22, and which is coaxial with the axis X. The openings 34 each have an overall length of approximately 0.440 inches and a central width of approximately 0.313 inches. The openings 34 are each arcuately equidistant from one other, and each opening 34 has a major axis of symmetry that coincides with a radius stemming from the central axis X. The openings 34 are each equidistant from the central axis X. A series of generally radial bores 36 are uniformly spaced about the outer perimeter of the plates 24 and 26. The bores 36 are formed by corresponding and mated grooves in the plates 24 ad 26, that are shaped, sized and oriented to fit snugly together over and against the spokes of a particular wheelchair wheel, such as for example the wheelchair W, as depicted and FIGS. 1-3 and as further described in application Ser. No. 17/669,436.

### Representative Lock-Pin Assembly

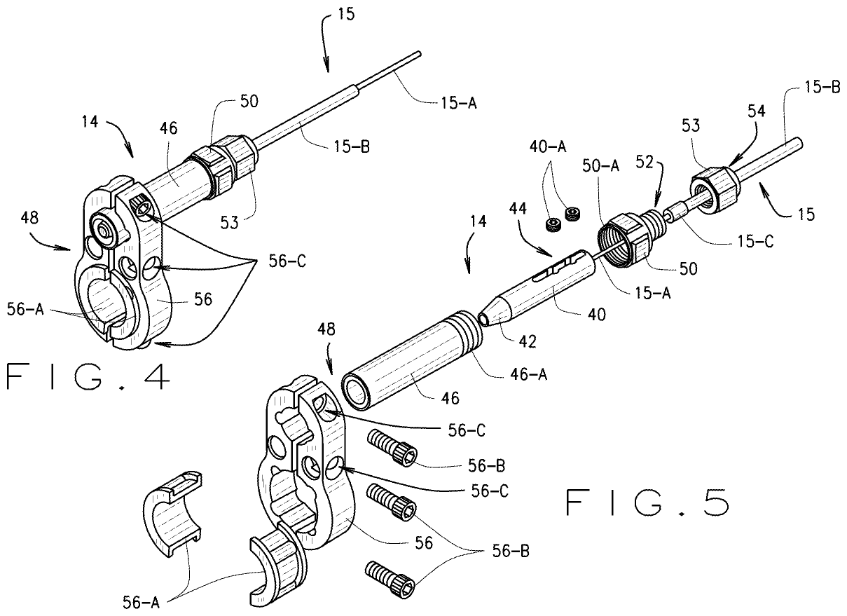

Referring now to FIGS. 4-5, each lock-pin assembly 12 includes a cylindrical metal lock-pin 40 that has a pointed tip 42 at one end and a connection slot 44 at the end opposite the tip 40. The lock-pin 40 is slidably positioned in a cylindrical housing 46 that has an open end 48 and a threaded end 46-A opposite the open end 48, which is partially closed by an endcap 50. The endcap 50 has a circular axial through bore 52 in its center. The endcap 50 has an inner threaded surface 50-A that attaches to the threaded end 46-A of the cylindrical housing 46. The endcap 50 also has an outer threaded butt 50-B opposite the inner threaded surface 50-A. Notably, there are no biasing members in or directly associated with the lock-pin assembly 12.

Referring again to FIGS. 4 and 5, and as would be readily understood by one of ordinary skill in the art, each of the cables 15 includes a flexible central wire 15-A that is housed in a flexible cylindrical composite sleeve 15-B. At each end of each of the cables 15, the sleeve 15-B ends at a metal ferrule 15-C. The central wire 15-A then extends a short distance out of the sleeve 15-B beyond the ferrule 15-C. As can be further recognized, when sufficient axial force is applied to pull or push the central wire 15-A while the sleeve 15-B is held in place, the central wire 15-A can be controllably moved in an axial direction inside the sleeve 15-B.

One end of each of each of the cables 15 attaches to each of the lock-pin assemblies 12. A lock nut 53, having a circular axial through bore 54, and housing the cable 15 in the through bore 54, threads onto the threaded butt 50-B of the endcap 50. The axial through bore 54 has a diameter that is of a shape and size to allow the sleeve 15-B to be positioned through the bore 54, but prevents the ferrule 15-C to do so. In this way, the locknut 53 secures the cable ferrules 15-C between the lock nut 53 and the endcap 50 as shown, such that the cable sleeve 15-B remains in a substantially fixed or locked position relative to the housing 46.

As can be seen, the lock-pin 40 is sized and shaped to slide axially in both directions within the tubular housing 46 such that the pin tip 42 can extend horizontally outward from and retract inward through the open end 48 of the housing 46. At the other end of the lock-pin 40, the connection slot 44 receives the exposed end of the wire 15-A, and two Allen nuts 40-A are threaded into the slot 44 and tightened down onto the wire 15-A to secure the wire 15-A to the lock-pin 40 in the slot 44.

A two-piece adjustable pipe clamp 56 is positioned about the housing 46 (as shown in FIGS. 4 and 5) and the wheelchair frame proximate the inner plate 22 of the plate assembly 16 (see FIGS. 1-3). A two-piece inner metal sleeve 56-A is positioned in the pipe clamp 56 to strengthen the clamp's attachment to the wheelchair frame. A set of three machine screws 56-B are screwed into corresponding threaded bores 56-C in the clamp 56 and tightened down to snugly secure the clamp 56 to both the housing 46 and the wheelchair frame, which thereby secures the lock-pin assembly 12 to the wheelchair proximate the spoked wheels W.

The lock-pin 40 selectively and releasably engages whichever of the openings 34 of the plate assembly 16 that is rotationally oriented nearest the lock-pin 40 at any given time, and in doing so rotationally “locks” in place the plate 22 and thereby the plate assembly 16 and the wheel W to which the plate assembly 16 is attached. Hence, the lock-pin 40 prevents the rotation of the plate 22, and hence the spoked wheel W, about its central axis X when the lock-pin 40 is engaged with any one of the openings 34. Disengaging the lock-pin 40 from the openings 34 removes this restriction from the plate 22, and hence allows the wheel W to rotate about the axis X.

### Representative Actuator

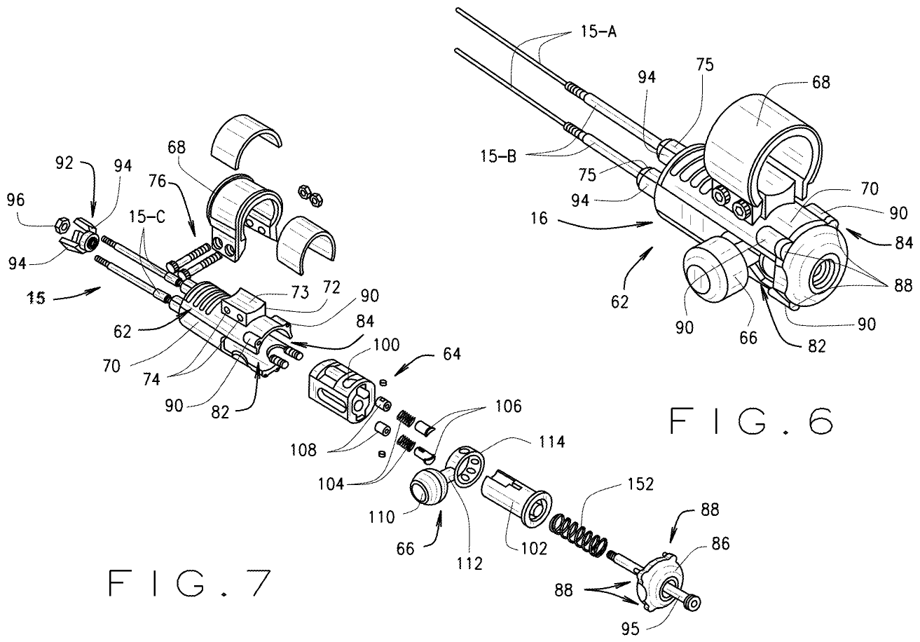

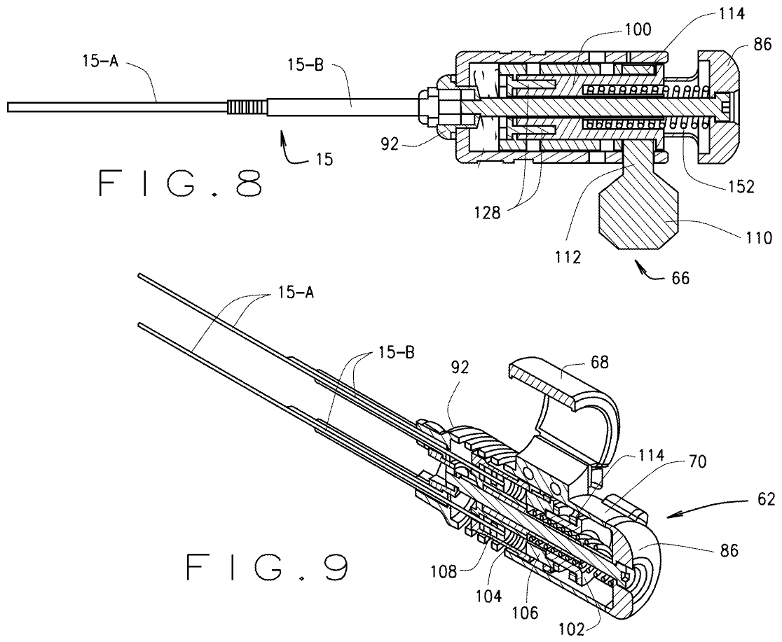

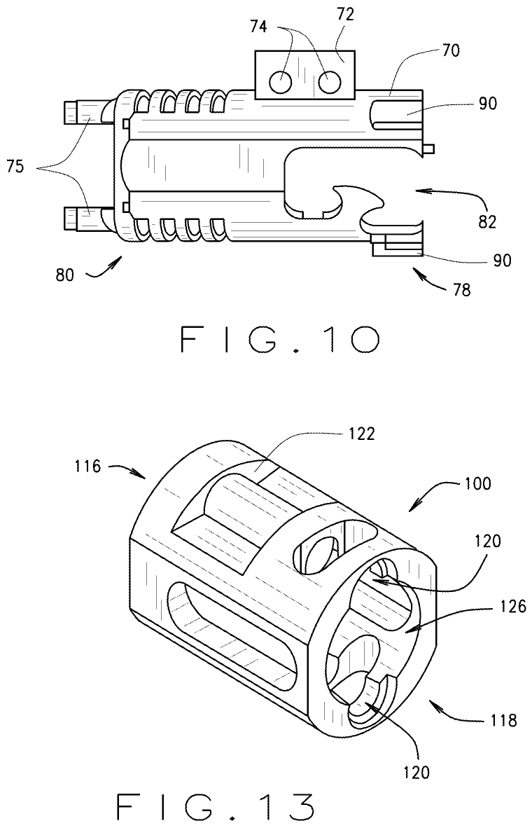

Each of the control cables 15 extends from its respective lock-pin assembly 12 to the remote actuator 14 (FIGS. 6-9) that is positioned proximate one of the wheelchair's armrests. The actuator 14 includes, inter alia, a tubular housing 62, a center slide or piston subassembly 64, a lever 66, and a tube mount 68.

The actuator housing 62 has a polymeric tubular body 70 in the shape of a flattened ellipse, with an inner height of approximately 1.3 inches, an inner width of approximately 1.155 inches, a length of approximately 2.5 inches, and sidewall thickness of approximately 0.15 inches. A longitudinal tab 72 with an upper semicircular trough 73 extends upward from the top of the body 70 and includes a set of through bores 74 on each side for the attachment of the tube mount 68 using a pair of matching machine screws 76 (FIG. 7). Referring to FIG. 10, the housing 62 has a front end 78 and a back end 80. A pair of inward facing, short semi-cylindrical troughs 75 protrude in a parallel fashion from the back end 80 of the body 70. A horizontally-oriented and “J-shaped” first slot 82 is formed in the right-hand side of the housing 62. A matching horizontally-oriented and “J-shaped” second slot 84 is formed in the left-hand side of the housing 62 opposite the first slot 82. Both the first slot 82 and the second slot 84 are approximately 0.400 inches wide and stretch from the approximate center of the body 70 to the front end 78. Further, both the first slot 82 and the second slot 84 include a “hook” at each end, and are both closed at their forward end by the endcap 86.

Referring again to FIGS. 6 and 7, it can be seen that a generally flat and circular, rounded front endcap 86 is shaped to fit against and close the front end 78 of the housing 70. A set of four short prongs 88 protrude from one end of the endcap 86 to extend into a set of short matching bores 90 positioned about the front end 78. A set of four short, parallel inward-facing prongs 88 protrude from one end of the endcap 86 to extend into and secure within a set of short matching bored tabs 90 positioned about the front end 78. Similarly, a plug-shaped endcap 92 is shaped to fit into and close the back end 80. A pair of outward facing, short semi-cylindrical troughs 94 protrude in a parallel fashion from the distal end of endcap 92. The troughs 94 are shaped and sized to mate with the corresponding troughs 75 that protrude from the body 70, so as to form a pair of through bores when the endcap 92 is properly attached to the body 70. A shoulder bolt 95 extends axially through a bore in the center of the endcap 86, axially through the center of the body 70, and axially through the endcap 92, where it is secured to the housing 62 by a nut 96. As can be appreciated, the shoulder bolt 95 not only holds the lever assembly 16 together, but also acts as a centering slide or rail for the piston 100. The endcap 92 and the troughs 94 are collectively sized and shaped to tightly secure each of the ferrules 15-C for the cables 15 in a cavity between the endcap 92 and housing 62, such that the sleaves 15-B for each of the cables 15 remain in a fixed position relative to the housing 62.

The polymer tube mount 68 attaches to and extends upwardly from the sides of longitudinal tab 72. The screws 76 and their matching nuts secure the strap 68 to the longitudinal tab 72. The tube mount 68 releasably attaches to a tube frame or other accessible frame structure of a wheelchair (see FIGS. 1-3) to secure the actuator 14 to the wheelchair, preferably near an armrest.

Referring now to FIGS. 11-13, the piston subassembly 64 includes a generally cylindrical polymer piston 100, a slightly smaller generally cylindrical polymer piston cap or plug 102, a pair of biasing members, i.e., small compression cable springs 104, a pair of small semi-cylindrical polymer spring plugs 106, a pair of cylindrical metal cable slides 108, and the lever 66. The lever 66 includes a lever handle or grip 110, which is attached to a stem 112, which in turn attaches to a circular collar 114. All components of the lever 110 are polymeric. The piston 100 has a proximal end 116 and an opposing distal end 118 (see FIG. 1). Two radially opposed and axially parallel longitudinal bores 120 are formed in the piston 100. The bores 120 each extend from openings in the distal end 118 to a narrow and perpendicular rear wall 122 that forms the proximal end 116.

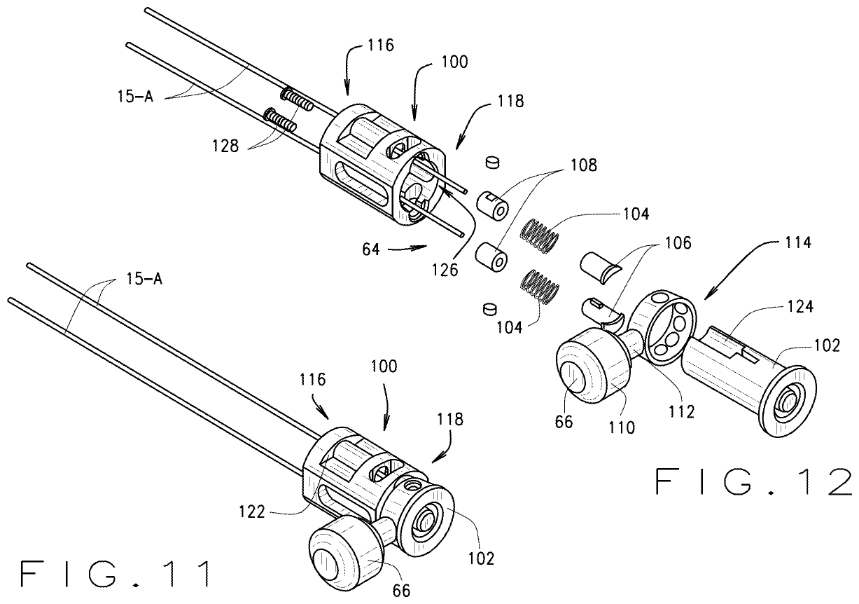

Referring to FIGS. 11 and 12, the cable wires 15-A extend into the proximal end 116 of the piston 100 through a pair of radially opposing bores 124 in the rear wall 122 that are each centered on the proximal end of one of the two bores 120. The slides 108 each securely fasten to the end of one of the cable wires 15-A inside tubular bores 120 in the piston 100 proximate the rear wall 122. Each of the cable springs 104 is positioned longitudinally in one of the bores 120 proximate its respective slide 108. Next, each of the spring plugs 106 is positioned longitudinally in one of the bores 120 proximate its respective spring 104. As can be seen, piston plug 102 has two radially opposed and axially parallel longitudinal semi-circular grooves 124 formed in its side. The piston plug 102 fits slidingly into the lever collar 114, and then slides into a large bore 126 in the distal end 118 of the piston 100, where the grooves 124 mate with the spring plugs 106 in the tubes 116. A pair of screws 128 are pushed through bores in the rear wall 122 of the piston 100 and threaded into the piston plug 102 to secure the plug 102 in the piston 100 and hold the springs 104, spring plugs 106, and cable slides 108 inside the piston 100. The screws 128 further secure the lever collar 114 between an outer lip on the piston plug 102 and the piston distal end 118.

As can be seen in the various Figures, and readily appreciated by one of ordinary skill in the art, when fully assembled as shown in FIGS. 6, 8 and 9, the piston subassembly 64 is to be positioned in the tubular housing 62 of the actuator 14 (see FIGS. 7-9). When the piston subassembly 64 is properly positioned in the housing 62 as shown, the lever stem 112 extends out of the housing 62 through the slot 82. The lever grip 110 can therefore be readily grasped so as to direct the lever 66 to any position along the slot 82.

As can also be appreciated, when the lock-pin assembly 12 is secured to the frame of a wheelchair, as shown by way of example in FIGS. 1-3, and when the actuator 14 is secured to a different part of the same wheelchair frame (such as for example under the armrest as shown in FIGS. 1-3), moving the lever 66 forward and back in the slot 82 will simultaneously and correspondingly move the lock-pin 40 in the lock-pin housing 46 into and out of engagement with the plate assembly 16. More particularly, when the lever 66 is moved forward in the slot 82, the lock-pin 40 will move away from and out of engagement with the plate assembly 22. Conversely, when the lever 66 is moved rearward in the slot 82, the lock-pin 40 will move toward and ultimately engage the plate assembly 22.

A strong coiled compression spring 152 is positioned longitudinally inside the housing 62 between the front of the piston 100 and the endcap 86 of the housing 62. When compressed, the spring 152 exerts an axial force against piston 100 to urge the piston rearward and away from the endcap 86. Thus, when the lever 66 has been pushed fully forward by the user, and rotated downward into the lower curve of the slot 82, then the lever 66 can be released by the user and the spring 152 will releasably “lock” the lever 66, and by association the piston 100, in a forward orientation as defined by the lower curve of the slot 82.

Thus, as can be appreciated, although the spring 152 will tend to urge the piston 100 rearward to force the lock-pins 40 to engage their associated plate assemblies 16, in the case of a mechanical failure of the lock-pin system (such as for example the breaking or separation of one or more of the cables 15), the spring 152 be unable to undesirably urge both of the lock-pins 40 into engagement with the lock plates 16.

In addition, it has been found by the Applicant that the cables 15 may tend to bind, and therefore operate improperly, when attached directly to the piston 100 and when the piston 100 is urged forward or backward in the housing 62. Cable springs 104 provide an elastic buffer between the piston 100 and each of the cables 15 to reduce the likelihood of such binding.

While I have described in the detailed description a configuration that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel improved wheelchair wheel lock system 10 of the present invention can be arranged in a number of other and related varieties of configurations without expanding beyond the scope of my invention as set forth in the claims.

For example, the actuator 14 may be constructed with a variety of mechanisms well-known in the art, other than the piston configuration disclosed above, so long as the actuator 14 is capable of performing the functions as described herein. That is, the actuator 14 may be configured to utilize, for example, a slide mechanism, a rotary gear, or a simple lever, in place of the piston subassembly 64. Further, the actuator 14 and the piston subassembly 64 may be configured differently, so long as the actuator 14 allows the user to controllably move the wires 15-A in the cable sleeves 15-B to actuate the lock-pins 40.

Further, although the various biasing members are shown as springs of different sorts in the embodiments described above, such biasing members may alternatively be any of a variety of components well-known in the art that provide an appropriate mechanical force. These may include, for example, cushions, spring metal levers, air or hydraulic pressure devices, etc. Further, each biasing member may comprise two or more component biasing members.

In addition, the biasing members need not be located in the particular positions disclosed above. Rather, so long as the biasing member is positioned so as to be capable of applying an appropriate mechanical force in the direction indicated for the system 10 to function as described and claimed, each biasing member or spring may be positioned at other locations in the system 10—other than proximate the lock-pin assembly 12, for the reasons explained above. That is, the biasing members that urge the lock-pin 40 into engagement with the lock plate 16 must be separated from the lock-pin 40 and the lock-pin assembly 12. For example, the compression spring 152 may be positioned in either the actuator or along the first control cable 15, so long as the spring 152 (or any such biasing member(s) that provide the function of compression spring 152) is able to apply a mechanical force to urge the piston 100 toward the lock plate 16. Of course, it is preferable that the compression spring 152 (or any such biasing member(s) that provide the function of compression spring 152) be positioned in or proximate the remote actuator 14.

It is further possible for a metal lug to be securely attached to the end of the central wire 15-A as a grip for the wire. By way of further example, the lock-pin assembly 12 can be encased, at least in part, in a housing.

Of course, depending on its configuration, the lock plate 16 is not limited to having the particular number of openings 34 as depicted in FIG. 14. Rather, the openings 34 may instead include more or less openings 34, with a minimum of one. In addition, the openings 34 need not have the shape depicted in FIG. 14, and need not be an opening at all, depending on the manufacturer. That is, any one or more of the openings 34 may instead be shaped as any number of well-recognized engagement features, such as for example, through bores, grooves, depressions and/or detents—so long as the shape enables engagement with the lock-pins 40 as described herein.

Additional variations or modifications to the configuration of the above-described novel improved wheelchair wheel lock system 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A wheel lock system for a wheelchair, said wheelchair comprising a first wheel and a first wheel lock plate associated with said first wheel, said wheel lock plate having a first locking face, said wheelchair having a first frame portion proximate said first wheel lock plate and a second frame portion separated from said first frame portion, said system comprising:
a. a first control cable, said control cable having a first end and a second end opposite said first end;
b. a first lock-pin, said first lock-pin being positioned proximate said first wheel lock plate and oriented toward said first wheel lock plate first locking face, said first lock-pin being selectively movable between a first position in which said first lock-pin engages said first wheel lock plate first locking face and a second position in which said first lock-pin does not engage said first wheel lock plate first locking face, said first lock-pin being operatively associated with said first end of said first control cable, said first control cable urging said first lock-pin between said first and second positions;
c. a remote actuator, said actuator positioned proximate said second frame portion, said actuator comprising a grip, said grip being operatively associated with said second end of said first control cable, said grip moving between a first position in which said grip urges said first control cable to urge said first lock-pin into said first lock-pin first position and a second position in which said grip urges said first control cable to urge said first lock-pin into said first lock-pin second position; and
d. a first biasing member, said first biasing member being positioned proximate said first control cable at a location apart from said first lock-pin, said first biasing member urging said first control cable to urge said first lock-pin toward said first lock-pin second position.

2. The wheel lock system of claim 1, further comprising a first lock-pin assembly having a sleeve, said first lock-pin assembly comprising said first lock-pin, said first lock-pin being positioned in part in said sleeve, said first lock-pin assembly being attached to said wheelchair first frame portion.

3. The wheel lock system of claim 1, wherein said first biasing member is positioned proximate said remote actuator.

4. The wheel lock system of claim 1, wherein said remote actuator comprises a housing, said first biasing member being positioned in said remote actuator housing.

5. The wheel lock system of claim 4, wherein said remote actuator housing comprises a first slot and said remote actuator comprises a piston positioned in said remote actuator housing, said grip attaching to said piston through said first slot, said grip being movable in said first slot to selectively urge said piston forward or backward within said housing, said piston being operatively associated with said first control cable such that said piston urges said first control cable forward and backward in response to said urging from said grip.

6. The wheel lock system of claim 5, wherein said first slot comprises a shape having a hook, said hook being oriented at least in part in the direction of said piston travel urged by said first biasing member.

7. The wheel lock system of claim 5, wherein said remote actuator housing comprises a second slot, said second slot being positioned substantially opposite said first slot, said grip being selectively attachable to said piston through one of said first and second slots, said grip being movable in said second slot to selectively urge said piston forward or backward within said housing, such that said piston urges said first control cable forward and backward in response to said urging from said grip.

8. The wheel lock system of claim 1, wherein said grip is releasably lockable in one of said grip first position and said grip second position.

9. The wheel lock system of claim 1, wherein said first biasing member urges said grip into said one of said grip first position and said grip second position.

10. The wheel lock system of claim 5, wherein said remote actuator further comprises a first mechanical float operatively associated with said first control cable and said piston, said first mechanical float buffering forces imposed by said first control cable on said piston.

11. The wheel lock system of claim 10, wherein said first mechanical float comprises a biasing member, said biasing member urging said first mechanical float in a direction away from said piston.

12. The wheel lock system of claim 1, wherein said wheelchair comprises an armrest and said remote actuator attaches to said wheelchair proximate said wheelchair armrest.

13. The wheel lock system of claim 1, wherein said first wheel lock plate first locking face comprises one of a hole, a groove, a depression and a detent, said one of a hole, a groove, a depression and a detent being shaped and sized to receive at least a portion of said first lock-pin when said first lock-pin is in said first lock-pin first position, said first lock-pin being positioned and oriented relative to said first wheel lock plate for at least a portion of said first lock-pin to engage said one of a hole, a groove, a depression and a detent when said first lock-pin is in said first lock-pin first position.

14. A wheel lock system for a wheelchair, said wheelchair comprising a first wheel and a first wheel lock plate associated with said first wheel, said wheel lock plate having a locking plate with a plurality of locking openings, said wheelchair having a first frame portion proximate said first wheel lock plate and a second frame portion separated from said first frame portion, said system comprising:
a. a first control cable, said control cable having a first end and a second end opposite said first end;
b. a first lock-pin, said first lock-pin being positioned proximate said first wheel lock plate and oriented toward said first wheel lock plate first locking face, said first lock-pin being selectively movable between a first position in which said first lock-pin engages one of said plurality of locking openings and a second position in which said first lock-pin does not engage any of said locking openings, said first lock-pin being operatively associated with said first end of said first control cable, said first control cable urging said first lock-pin between said first and second positions;
c. a remote actuator, said actuator positioned proximate said second frame portion, said actuator comprising a grip, said grip being operatively associated with said second end of said first control cable, said grip moving between a first position in which said grip urges said first control cable to urge said first lock-pin into said first lock-pin first position and a second position in which said grip urges said first control cable to urge said first lock-pin into said first lock-pin second position; and
d. a first biasing member, said first biasing member being positioned proximate said first control cable at a location separate from said first lock-pin, said first biasing member urging said first control cable to urge said first lock-pin toward said first lock-pin second position.

15. The wheel lock system of claim 15, further comprising a first lock-pin assembly having a sleeve, said first lock-pin assembly comprising said first lock-pin, said first lock-pin being positioned in part in said sleeve, said first lock-pin assembly being attached to said wheelchair first frame portion.

16. The wheel lock system of claim 15, wherein said grip is releasably lockable in one of said grip first position and said grip second position.

17. The wheel lock system of claim 15, wherein said first biasing member urges said grip into said one of said grip first position and said grip second position.

18. The wheel lock system of claim 15, wherein said first lock-pin is positioned and oriented for selective engagement in any one of said plurality of locking openings.

19. The wheel lock system of claim 15, wherein said first biasing member is positioned proximate said remote actuator.

20. The wheel lock system of claim 15, wherein said remote actuator comprises a housing, said first biasing member being positioned in said remote actuator housing.

21. A cable-securing assembly for a wheelchair wheel lock system, said wheel lock system comprising a control cable, said control cable having a first end and a second end opposite said first end, said control cable comprising a central wire surrounded by a sleeve, said central wire being axially movable within said sleeve, said assembly comprising:
a. a first ferrule, said first ferrule attaching to said control cable sleeve proximate said first end;
b. an attachment member, said attachment member securing said control cable first end to said wheel lock system;
c. a securement member, said securement member attaching to wheel lock system, said securement member and said wheel lock system having a gap there between, said ferrule being positioned between said securement member and said wheel lock system, said securement member being shaped and sized to prevent said ferrule from moving past said securement member.

22. The cable-securing assembly of claim 21, wherein said securement member comprises a through bore, said control cable being positioned through said through bore, said through bore being shaped and to prevent said ferrule from moving there through.

23. The cable-securing assembly of claim 21, wherein said securement member tightens against said wheel lock system.

24. The cable-securing assembly of claim 23, wherein said securement member threads onto said wheel lock system.

25. The cable-securing assembly of claim 21, wherein said securement member tightens against said ferrule, said ferrule thereby tightening against said wheel lock system.
